(19) United States
(12) Patent Application Publication
(10) Pub. No.: US 2023/0311062 A1
(43) Pub. Date: Oct. 5, 2023

(54) Biofilter for Biological Purification of a Waste Gas Stream Containing Impurities

(71) Applicant: Hartmann Biofilter GmbH & Co. KG, Lichtenau (DE)

(72) Inventors: Christian Hartmann, Lichtenau (DE); Anton Hartmann, Lichtenau (DE); Magdalena Hartmann, Lichtenau (DE); Alessandro Siegel, Lichtenau (DE)

(21) Appl. No.: 18/006,416

(22) PCT Filed: Jul. 8, 2021
(86) PCT No.: PCT/EP2021/069036

§ 371 Date: Jan. 23, 2023

(30) Foreign Application Priority Data
Jul. 24, 2020 (DE) 10 2020 119 628.8

(51) Int. Cl. B01D 53/85

(52) U.S. Cl. CPC B01D 53/85; B01D 2251/95; B01D 2257/406; B01D 2257/90; B01D 2258/06; B01D 2258/0266; B01D 2258/05; B01D 2258/0258

(57) ABSTRACT

The invention relates to a biofilter for biologically cleaning a waste gas stream containing contaminants, having at least one filter module through which the waste gas stream is to flow. The filter module has at least one filter layer containing an organic filter material, and the at least one filter layer being supported by at least one grating structure which is in particular oriented at least substantially horizontally. According to the invention, so that the biofilter can be operated cost-effectively, with low effort and with a high filtering efficiency over the longest possible period, the at least one grating structure formed by elongate grating elements which are arranged at least substantially crosswise and are in particular oriented at least substantially horizontally.

### CROSS-REFERENCE TO RELATED APPLICATIONS

This application is the United States national phase of International Application No. PCT/EP2021/069036 filed Jul. 8, 2021, and claims priority to German Patent Application No. 10 2020 119 628.8 filed Jul. 24, 2020, the disclosures of which are hereby incorporated by reference in their entirety.

### BACKGROUND OF THE INVENTION

### Field of the Invention

The invention relates to a biofilter for the biological purification of an exhaust gas stream containing contaminants, having at least one filter module through which the exhaust gas stream is to flow, the filter module having at least one filter layer comprising an organic filter material, and the at least one filter layer being supported by at least one, in particular at least substantially horizontally oriented, grid structure.

### Description of Related Art

Biofilters are used for the biological purification of waste gas streams containing biodegradable impurities, such as odorous and/or harmful substances. The contaminants are typically substances that are gaseous under normal ambient conditions. In addition to a wide variety of organic contaminants, biofilters can also be used to biodegrade inorganic contaminants, such as ammonia in particular, in waste gas streams. This makes it possible to use biofilters in a variety of ways to clean waste gas streams, which usually occur in the form of exhaust air streams but do not have to. For example, biofilters are used to purify exhaust air streams from slaughterhouses or animal husbandry facilities, such as animal stables, and exhaust gas streams from smoking operations, sewage treatment plants, paint and varnish processing plants, or plastics processing plants.

Irrespective of the type of exhaust gas stream to be cleaned and the contaminants contained therein, biofilters generally have at least one filter module through which the exhaust gas stream flows. The exhaust gas stream typically flows through at least one biologically active filter layer of the filter module, in which the contaminants are biodegraded by microorganisms, such as bacteria, fungi and/or yeasts, which are settled on the filter material of the filter layer. The filter material is usually an organic material such as bark mulch or wood chips, which can also serve as a substrate for the microorganisms. The microorganisms typically convert the interfering substances into other compounds, preferably carbon dioxide and water, by oxidation with atmospheric oxygen. In this process, the activity of the microorganisms is crucially dependent on the conditions prevailing in the filter layer, such as temperature, pH and nutrient supply, among others. In this context, the moisture content of the filter material is of particular importance, since sufficient water activity in the filter material is a basic prerequisite for the microbiological degradation processes.

In addition to the filter layer, the filter module typically has at least one grid structure that supports the filter layer. In this case, the grid structure is typically aligned at least essentially horizontally, with the filter layer being arranged above the grid structure. Frequently, the grid structures are designed as slatted floors made of concrete from screen perforated floors which, on the one hand, bring with them sufficient stability to be able to safely support the weight of the filter layer and, on the other hand, allow a uniform flow through the exhaust gas stream. In addition, however, the grid structures should not be too easily blocked or even clogged locally by the filter material, for example by finer constituents of the filter material, such as those formed when the filter material is decomposed by the microorganisms, since this can result in an uneven flow through the filter material. Uneven flow through filter materials also tends to cause local drying, which reduces the overall performance of the biofilter. In turn, the grid structure should allow excess moisture to easily drip down from the filter layer and be provided at low cost.

These are just a few reasons why known biofilters are not yet able to satisfactorily meet the partly conflicting requirements in terms of functionality, moisture balance, durability, operating costs and manufacturing costs.

### SUMMARY OF THE INVENTION

Therefore, the present invention is based on the task of designing and further developing the biofilter of the type mentioned at the beginning and described in more detail above in such a way that the biofilter can be operated cost-effectively, with less effort and with a high filter efficiency over as long a period as possible.

This task is solved in a biofilter as described in that the at least one grid structure is formed by at least substantially crosswise arranged elongated, in particular at least substantially horizontally aligned, grid elements.

Since the grid structure is formed by the elongated grid elements arranged at least essentially crosswise, the grid openings formed by the grid structure can be made larger if the grid structure is sufficiently stable. In this way, it can be ensured that partial areas of the grid structure do not become clogged or blocked, or at least not so quickly, so that the flow through the filter layer will not be highly inhomogeneous. In this way, the biofilter can be operated for a longer period of time at high efficiency without the need to clean the grid openings or replace the filter material of the filter layer.

Depending on the volumetric flow of the exhaust gas to be cleaned, it may be sufficient for the biofilter to have only one filter module. For higher volume flows, however, the biofilter can also have several filter modules, in particular of the same design. In this case, the filter modules are then preferably connected in parallel, so that the exhaust gas flow flows through the filter modules in parallel. In this way, a failure of a filter module can be compensated for if necessary, for example due to maintenance work, without the exhaust gas flow being released into the environment unpurified.

The filter layer has at least one organic filter material. Organic filter materials offer the advantage over inorganic filter materials that they already naturally have a high population density and a large species diversity of microorganisms and also serve as a source of nutrients for the microorganisms, which reduces the effort required to start up and operate the biofilter. In this context, the at least one filter layer can in principle also comprise one or more inorganic filter materials, such as expanded clay or lava, in addition to the at least one organic filter material. For the aforementioned reason, however, it is particularly preferred if the at least one filter layer is formed at least substantially from the at least one organic filter material.

The at least one filter layer is supported by the at least one grid structure. Thereby, a simple and at the same time stable construction of the grid structure can be enabled if the at least one grid structure is oriented at least substantially horizontally. Then, the grid structure can extend at least substantially parallel to the bottom of the filter module and the overall height of the biofilter can be kept low. Alternatively or additionally, the grid structure can be easily constructed if the filter layer is arranged above the grid structure.

The grid elements forming the grid structure are each elongated. An elongated design of a grid element is understood to mean in particular that the extension of the grid element along its longitudinal direction is at least 2 times, preferably at least 5 times, in particular at least 10 times, as large as the extension of the grid element in each of the transverse directions aligned perpendicular to the longitudinal direction, i.e. in particular the width and the height. Irrespective of the elongated design of the grid elements, it is preferred if these are each oriented at least substantially horizontally taken separately. Then the grid elements can each be aligned at least substantially parallel to the bottom of the filter module. This can have a positive effect on the effort required for the construction of the grid structure. For the same reason, it may also be suitable alternatively or additionally if the grid elements each have an at least substantially constant cross-section, in particular along the longitudinal axis.

In principle, it may be sufficient if the filter module has only one filter layer. In many cases, however, it may be preferable to achieve a sufficient filtration efficiency if the filter module has at least two filter layers through which the exhaust gas stream flows in succession. From a design point of view, it is advantageous if the filter layers are arranged one above the other. Then the exhaust gas stream can expediently flow through the filter layers in vertical direction one after the other, in particular from bottom to top. Irrespective of this, it may be expedient if the filter layers are each supported by a grid structure. Then, for the above-mentioned reasons, it is also advantageous if the grid structures are each formed by elongated grid elements arranged at least substantially crosswise.

In a first particularly preferred embodiment of the invention, the grid elements of the at least one grid structure are each lath-shaped, beam-shaped and/or rod-shaped. Due to their geometry, grid elements in the form of battens, beams and bars enable simple construction of the grid structure and also provide a high area moment of inertia. A design in the form of battens and/or beams is particularly suitable because of their typically rectangular cross-section, not least because they can be conveniently placed one on top of the other. Beams also offer the advantage that they are particularly stable due to their larger cross section.

For quick and easy production of the grid structure, it is particularly useful if the grid elements of the grid structure are at least substantially unconnected to one another. The grid elements can then simply be placed one on top of the other. However, for example for stabilizing the grid structure, it may also be expedient if the grid elements of the at least one grid structure are detachably connected to one another. The grid structure can then be simply joined, whereby individual grid elements can be simply replaced if necessary, for example due to decomposition by the microorganisms settled in the filter module and/or corrosion. For simplicity, the detachable connections between the grid elements are positive and/or non-positive connections, for example screw connections or snap-in connections.

The grid elements of the at least one grid structure can be formed from plastic and/or metal for the sake of durability. However, it is particularly preferred from a cost point of view and for the moisture balance of the biofilter if the grid elements of the at least one grid structure are formed from wood and/or a wood-based material. In this context, a wood-based material is understood to mean in particular one which is formed at least predominantly from pieces of wood, wood chips or wood fibers. If, on the other hand, the grid elements are formed from wood or solid wood, these can be formed as sawn wood for the sake of simplicity. Sawn wood can be produced particularly simply and inexpensively by sawing a log or a log section at least substantially parallel to the log axis. In this context, the wood may in particular be a coniferous wood. Coniferous woods are decomposed less quickly than deciduous woods by the microorganisms settled in the filter module and therefore have a longer service life than deciduous woods. Coniferous wood is particularly suitable as fir wood and/or spruce wood. These are subject to particularly slow decomposition. For the same reason, it may alternatively or additionally be provided that the wood material is formed at least substantially from a coniferous wood, in particular from fir wood and/or spruce wood.

Regardless of the design of the grid elements, it can be useful if the at least one grid structure is formed from at least two grid layers. In this way, a particularly stable grid structure can be provided in a simple manner by doubling simple grid layers or even more often providing them one above the other. In addition, this increases the internal surface area of the grid structure, which can be involved to a not inconsiderable extent in the biological conversion of the exhaust gas stream, and in particular in the case of grid elements made of wood and/or a wood-based material. For stability reasons, the grid structure can be composed of at least three, in particular at least four, grid layers.

Regardless of the number of grid layers, it can be useful if the grid layers are each formed by elongated grid elements arranged crosswise. This can also very easily contribute to a high stability of the grid structure. Alternatively or additionally, the grid layers can be arranged on top of each other for simplicity. Independently of this, it can also contribute to a simple structure of the biofilter if the grid layers are each formed at least substantially horizontally. Then, the grid layers may each extend at least substantially parallel to the bottom of the filter module.

It may also contribute to the ease of construction of the grid structure if the grid elements of the at least one grid structure cross each other at least substantially at a right angle. Thus, the angle between the grid elements crossing each other may then be at least substantially 90° . However, an exactly right-angled arrangement will not be important in many cases. Minor deviations can be tolerated as long as use is made of an overall substantially rectangular arrangement. If the grid structure is formed from a number of grid layers, it is advisable for the same reason for the grid elements of each grid layer to cross each other at least substantially at right angles.

To allow the exhaust gas to flow unhindered through the grid structure, it is useful if grid openings are provided within the at least one grid structure as seen in the vertical direction. If the grid structure is formed from several grid layers, corresponding grid openings can also be provided within the grid layers as an alternative or in addition for the same reason. In order to avoid clogging of the grid openings, for example by increasingly rotting filter material, as effectively as possible over time, it is advantageous if the grid openings each have a width and/or length of at least 10 cm. Clogging of the grid openings can be avoided particularly reliably if the width and/or length of the grid openings is at least 15 cm, in particular at least 20 cm. In principle, it can be sufficient if the grid openings have a corresponding minimum width or corresponding minimum length. For the above-mentioned reason, however, it is particularly preferred if the grid openings have a corresponding minimum width and a corresponding minimum length of the above-mentioned dimensions.

Alternatively or additionally, it may be advisable if the grid openings each have a width and/or length of at most 120 cm in order to be able to reliably support the filter material over a long period of time. This may be all the more the case if the width and/or length of the grid openings is at most 80 cm, in particular at most 60 cm. In this context, it is particularly preferred, for the reasons mentioned, if the grid openings have a corresponding maximum width and a corresponding maximum length, in each case of the aforementioned dimensions.

For a high stability of the grid structure and a uniform flow through the filter layer, it may be useful if the grid elements occupy at least 20% by volume of the volume of the at least one grid structure. For the same reason, it is particularly preferred if the proportion of the volume of the grid elements to the volume of the at least one grid structure is at least 30 vol. %, in particular at least 35 vol. %. Alternatively or additionally, for the same reasons, the grid elements should occupy, if necessary, at most 70% by volume of the volume of the at least one grid structure. This applies all the more if the volume fraction of the grid elements in the volume of the at least one grid structure is at most 60 vol. %, in particular at most 55 vol. %.

The grid elements of the at least one grid structure can each have a length of at least 80 cm. In this way, the effort required for the construction of the grid structure can be kept low. This applies all the more if the length of the grid elements is at least 120 cm, in particular at least 160 cm. With regard to simple handling of the grid elements during assembly of the grid structure, it may also be suitable, alternatively or additionally, if the grid elements of the at least one grid structure each have a length of at most 10 m. Particularly easy handling can be achieved if the length of the grid elements is at most 8 m, in particular at most 6 m.

Regardless of the length of the grid elements, the grid elements of the at least one grid structure can each have a thickness of at least 1 cm for stability reasons. At the same time, the longevity of the grid elements is thus increased if the grid elements are formed from an organic material, such as wood or a wood-based material. For these reasons, it is particularly preferred if the thickness of the grid elements is at least 2 cm, in particular at least 3 cm. Independently thereof, for the aforementioned reasons, it may also be suitable if the grid elements of the at least one grid structure each have a width of at least 5 cm. It may be further preferred if the width of the grid elements is at least 10 cm, in particular at least 15 cm.

For ease of handling and to limit the dead weight restricting stability, the grid elements of the at least one grid structure may each have a thickness of at most 15 cm. In this context, it may be even more convenient if the thickness of the grid elements is at most 10 cm, in particular at most 5 cm. Irrespective of the thickness of the grid elements, the grid elements of the at least one grid structure may each have a width of at most 80 cm for the reasons mentioned above. In this context, it may be particularly expedient if the width of the grid elements is at most 60 cm, in particular at most 40 cm.

If necessary, the thickness of a grid element is understood to be its smallest extension in the cross-section of the grid element. Alternatively or additionally, the width of a grid element can be its extension in a cross-section perpendicular to the smallest extension of the grid element in this cross-section. In a square or circular cross-section, the thickness and width of a grid element in this case would be at least approximately equal.

With regard to the at least one filter layer, it is simple and expedient if this is designed as a bulk layer in which, in particular, the filter material is loosely connected. Then the at least one filter layer can be produced in a simple manner by pouring the filter material. Alternatively or additionally, it may be suitable with regard to the filter layer if the filter material of the at least one filter layer comprises wood chips, in particular coniferous wood chips, bark mulch, fibrous peat, coconut fibers, torn root wood, biowaste compost, heather, wood wool and/or wood pellets. These materials are particularly suitable as filter materials in terms of surface area, colonization by microorganisms and degradability. Wood chips and especially coniferous wood chips are particularly preferred, as they are subject to comparatively slow decomposition, which has a positive effect on the service life of the filter layer. The filter material can be flowed through evenly and at the same time provide a high specific surface area if the upper screen cut or the maximum particle size is not greater than 6 cm, preferably not greater than 5 cm, in particular not greater than 4 cm.

Regardless of the design of the grid structure and the filter layer, it can be advantageous if a support layer is provided between the at least one filter layer and the at least one grid structure, which supports the filter layer above the grid structure and prevents excessive slipping of the filter material of the filter layer through the grid openings of the grid structure. This is especially true if the grid structure has large grid openings. Since the grid structure can already provide sufficient stability, the support layer can be less rigid and instead highly permeable to the exhaust gas flow. This can then preferably be achieved by a large number of relatively small passage openings. This ensures that the exhaust gas stream can flow unhindered through the support layer without the filter material trickling excessively through the support layer. Advantageously, the passage openings are designed in such a way that fine fractions of the filter material of the filter layer, such as those decomposed by the microorganisms, can pass through the support layer. These very fine fractions of the filter material, whose proportion in the filter layer normally increases with time, can clog the filter material locally, so that the flow through the filter layer becomes increasingly uneven. However, if these fine fractions of the filter material can trickle through the passage openings of the support layer or be washed out of the filter layer with excess moisture, uneven flow through the filter material can be avoided. Against this background, it may be advantageous if the passage openings each have a length and/or width of at least 2.5 cm, preferably at least 2 cm, in particular at least 1.5 cm, and/or at most 8 cm, preferably at most 6 cm, in particular at most 4 cm. Irrespective of the size of the passage openings, it can have a positive effect on a uniform flow through the filter module if the passage openings are arranged distributed at least substantially over the entire support layer.

With regard to the support layer, it may also be suitable, alternatively or additionally, if the at least one support layer is formed at least essentially from metal or plastic. These materials are usually quite durable in biofilters, and supporting layers made of metal can be manufactured quite easily, which reduces the manufacturing costs of the biofilter. To reduce corrosion and extend service life, stainless steel, a plastic-coated steel material, and/or a galvanized steel material may be suitable for the support layer. Compared to metal materials, plastics offer the advantage that they can be used in biofilters for a very long time and are less expensive than stainless steel. This applies in particular to polyethylene and/or polypropylene.

Irrespective of the material of the at least one support layer, this can simply and expediently be formed by at least one grid, at least one perforated grid, at least one mesh and/or at least one fabric. In this case, grids and perforated grids, which are typically at least substantially bending stiff, offer the advantage of high stability. Meshes and fabrics, on the other hand, which are typically at least substantially bending slack, can be manufactured more simply and at lower cost.

The at least one grid structure may have a layer thickness of at least 20 cm. This may contribute to a high stability of the grid structure. Therefore, it may be even more preferred if the layer thickness of the grid structure is at least 30 cm, in particular at least 40 cm. In order to obtain a compact design and to limit the dead weight of the grid structure, the at least one grid structure may have a layer thickness of at most 100 cm. A particularly compact design is thereby made possible if the layer thickness of the grid structure is at most 80 cm, in particular at most 60 cm. In principle, the layer thickness of the grid structure can be understood in particular as the extension of the grid structure in the vertical direction.

With regard to a satisfactory degree of separation and a sufficient dwell time, it is advisable for the at least one filter layer to have a layer thickness of at least 30 cm. This applies in particular if the layer thickness of the filter layer is at least 40 cm, in particular at least 50 cm. Alternatively or additionally, it may contribute to a compact design of the filter module if the at least one filter layer has a layer thickness of at most 150 cm. For the same reason, it may be particularly preferred if the layer thickness of the filter layer is at most 125 cm, in particular at most 100 cm. In this context, the layer thickness of the filter layer can quite basically mean in particular the extension of the filter layer in the vertical direction.

Regardless of the layer thickness of the grid structure and the filter layer, the at least one support layer can have a layer thickness of at most 5 cm. This also contributes to a compact design of the filter module. A particularly compact realization of the filter module is made possible if the layer thickness of the supporting layer is at most 3 cm, in particular at most 1 cm. In this context, the layer thickness of the support layer is understood to mean in particular its extension in the vertical direction.

A uniform inflow of the filter layer can be favored if an inflow chamber is provided below the at least one grid structure. The inflow can be particularly uniform if the at least one inflow chamber has a height of at least 20 cm, preferably at least 30 cm, in particular at least 40 cm. In order to be able to form the biofilters compactly and yet functionally, it is alternatively expedient if the height of the inflow chamber is at most 120 cm, preferably at most 100 cm, in particular at most 80 cm.

In order to provide a high efficiency of the biofilter, at least two, preferably at least three, filter layers can be provided in the at least one filter module. For the sake of simplicity, these are arranged one above the other so that the filter layers can be flowed through serially by the exhaust gas stream and/or each can be supported by a grid structure. For the reasons mentioned, it is also advisable if at least one support layer is provided between each of the filter layers and the grid structures. In addition, it is particularly expedient if the flow of the exhaust gas between the filter layers can be evened out, so that it is expedient if a separate inflow chamber is provided under each grid structure.

For the sake of simplicity, a supporting framework can be provided to support the at least one grid structure. In this case, the supporting framework can be arranged at least in sections in the inflow chamber. This may contribute to a simple construction of the supporting framework. For the same reason, it may alternatively or additionally be advantageous if the supporting framework supports at least substantially the entire weight force of the at least one grid structure and the at least one filter layer on the bottom of the filter module. Independently thereof, it may be provided that at least a part of the grid elements of the at least one grid structure rest on the supporting framework. This enables not only a particularly simple design, but also a particularly compact design of the filter module. The latter applies all the more if the grid elements resting on the supporting framework rest loosely on the supporting framework. In this case, separate fastening of the corresponding grid elements to the supporting framework can be dispensed with.

Provided that at least one lower grid structure and at least one upper grid structure of the at least one filter module arranged above the lower grid structure are provided, it may be convenient if the supporting framework supports both the at least one upper grid structure and the at least one lower grid structure. It may then be further convenient for the supporting framework to extend through the filter layer supported by the lower grid structure and at least substantially through the inflow chamber disposed below the upper grid structure. This allows the supporting framework to support the weight of the upper grid structure and the filter layer supported by it in a structurally simple manner. The design of the supporting framework can be further simplified if the supporting framework extends at least substantially vertically through the filter layer supported by the lower grid structure and the inflow chamber arranged below the upper grid structure. The structure of the filter module can also be provided analogously with more than two filter layers arranged one above the other. If necessary, the filter layers are then supported by a single supporting framework, with the supporting framework extending through all the inflow chambers, all the grid structures except for the uppermost grid structure, and all the filter layers except for the uppermost filter layer.

A stable and also durable design of the supporting framework can be achieved if the supporting framework is formed at least essentially from a steel material. In particular, this can be a galvanized steel material, a stainless steel material and/or a plastic-coated steel material. Alternatively or additionally, the supporting framework may be formed at least substantially from a plastic material. Plastics are lightweight, inexpensive and very durable. For these reasons, polyethylene and/or polypropylene, for example, is a suitable material for the supporting framework. Alternatively, the supporting framework can also be formed at least essentially from a wood-based material. Wood-based materials are not only cost-effective but also resistant to corrosion. However, wood-based materials decompose over time due to the microorganisms that settle in the biofilter. Against this background, solid wood is particularly suitable, especially coniferous woods such as fir and/or spruce.

Irrespective of the material used for the supporting framework, the supporting framework can be designed as a tubular frame. In this way, a relatively light yet stable supporting framework system can be realized in a simple manner. The tubular frame can be formed in a simple manner at least essentially from interconnected supporting tubes.

In order to be able to ensure sufficient filter material moisture at all times, at least one moistening device for moistening the filter layer can be assigned to the at least one filter layer. If several filter layers are provided, it can be useful to ensure sufficient filter material moisture in each of the filter layers if a corresponding moistening device is assigned to each of the filter layers. Regardless of whether one or more moistening devices are provided, the at least one moistening device can in a simple manner comprise at least one nozzle. Then, the at least one nozzle may be configured to apply a moistening fluid containing water to the filter layer associated with the nozzle. In addition to water, the moistening fluid can contain nutrients for the microorganisms settled in the filter layer. In most cases, however, this will not be necessary. Irrespective of this, the at least one moistening device, in particular the at least one nozzle of the at least one moistening device, can be arranged above the filter layer associated with the moistening device for the sake of simplicity.

In the event that the filter module has at least one lower filter layer and at least one upper filter layer arranged above the lower filter layer, it may be appropriate if the at least one feed line of the moistening device, which is assigned to the lower filter layer, i.e. which is designed in particular for moistening the lower filter layer, extends at least partially through the upper filter layer. Then the supply line of the moistening device associated with the lower filter layer can be connected in a simple manner to the supply line of the moistening device associated with the upper filter layer. Thus, the feed line of the lower humidification device does not have to be separately introduced into the filter module and mounted in the biofilter, which can have a positive effect on a simple structural design of the filter module. Against this background, it may be particularly preferred if the at least one feed line of the lower moistening device extends at least substantially through the upper filter layer. Alternatively or additionally, it may be convenient for simplicity if the at least one feed line of the moistening device associated with the lower filter layer also extends at least substantially through the grid structure supporting the upper filter layer.

In the event that the moistening device associated with the lower filter layer has several nozzles, the lower moistening device can also have several supply lines, each of which extends at least substantially through the upper filter layer and/or the upper grid structure. Then each nozzle can be assigned a, in particular separate, feed line.

With regard to the at least one supply line of the moistening device associated with the lower filter layer, it may also be suitable, alternatively or additionally, if the at least one nozzle of the lower moistening device is held on the supply line and/or is provided in an inflow chamber between the lower filter layer and the upper filter layer. In this way, the nozzle can be held suspended in the intended position in a simple and inexpensive manner. If the lower moistening device has several nozzles, it may be particularly suitable for the same reason if the nozzles are each held correspondingly on a, in particular separate, supply line.

Alternatively or additionally, it may be convenient if the at least one supply line of the moistening device associated with the lower filter layer is arranged, at least in sections, in at least one line duct which extends at least substantially through the upper filter layer. Thus, not only the effort required for the construction of the filter module can be reduced, but also the effort required for the refilling and replacement of the filter material of the upper filter layer. For the same reason, in the case where the moistening device associated with the lower filter layer has a plurality of supply lines, it may be advantageous if the supply lines are each arranged in sections in a, in particular separate, line duct. Irrespective of this, the at least one line duct can be formed by a tube and/or a hose in a structurally simple and inexpensive manner. Alternatively or additionally, the at least one line duct can be simply and expediently fastened to at least one of the grid elements of the grid structure supporting the upper filter layer.

Regardless of whether the line duct is formed by a pipe and/or a hose and how the line duct is mounted, it may be convenient if the at least one line duct and the at least one nozzle of the moistening device associated with the lower filter layer are formed such that the nozzle can be passed through the line duct. This can not only allow easy installation of the nozzle, but also simplify maintenance of the filter module. In particular, the nozzle can then be easily brought into the position intended for the nozzle from above through the line duct and, for example in the event of a defect of the nozzle, can be pulled out through the line duct, in particular from the inflow chamber arranged below the upper grid structure.

Previously, the design of a filter module with an upper filter layer and a lower filter layer in connection with a moistening device was described in particular. In principle, an analogous design of the filter module is also conceivable for three or more filter layers. In this case, at least one nozzle is arranged above each filter layer, the feed line of which passes through the filter layers provided above it, if necessary through corresponding pipes and/or hoses.

In order to simplify the effort for moistening the filter layer, a control device can be provided which is designed to control the at least one moistening device. The at least one moistening device can be controlled in particular as a function of at least one measured moisture value, which is measured by at least one moisture sensor. The moisture measurement can be measured, for example, by means of at least one microwave sensor. In this way, not only can it be reliably prevented that the filter material dries out, but also that the filter material is excessively moistened and waterlogging occurs in the filter material, which has a negative effect on the uniform flow through the filter layer. For the sake of simplicity, it may be useful if the at least one moisture sensor is designed to measure the filter material moisture of the at least one filter layer.

Irrespective of whether the biofilter has a moistening device or not, it can be useful if the at least one filter module is open at the top. In this way, the precipitation falling on the filter module from above can be used in a simple manner for moistening the filter material, thus reducing the effort required for moistening the filter material. In principle, it may be sufficient if the filter module is open at the top only over a partial area of the horizontal extension of the at least one filter layer. With regard to a uniform moisture input into the filter material by precipitation, however, it is particularly suitable if the filter module is open at least substantially over the entire horizontal extent of the at least one filter layer.

### BRIEF DESCRIPTION OF THE DRAWINGS

The invention is explained in more detail below by means of a drawing which merely illustrates an example of an embodiment. The drawing shows

FIG. 1 a schematic vertical sectional view of a biofilter according to the invention,

FIG. 2 a detail of the biofilter from FIG. 1 in a schematic vertical sectional view and

FIG. 3 detail of the biofilter of FIG. 1 in a schematic horizontal sectional view from above.

### DESCRIPTION OF THE INVENTION

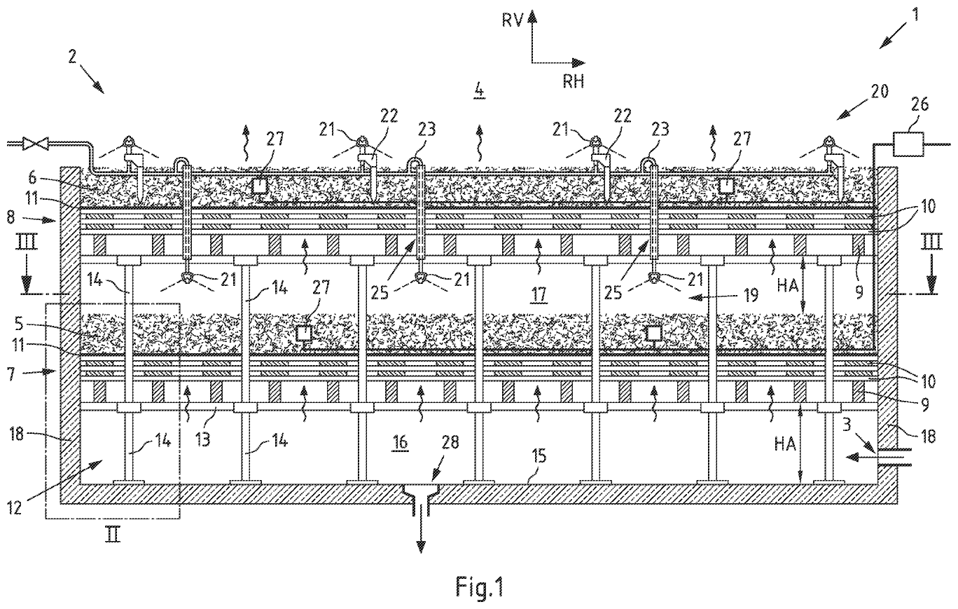

In FIG. 1, a biofilter 1 is shown in a schematic vertical sectional view. The biofilter 1 is used for biological purification of an exhaust gas stream containing biodegradable contaminants, such as odors and/or pollutants. In the illustrated and in this respect preferred embodiment example, the biofilter 1 has a filter module 2. The contaminated exhaust gas stream is fed to the filter module 2 via an inflow opening 3, which then flows upwards through the filter module 2 at least substantially in the vertical direction RV and is finally discharged as a cleaned exhaust gas stream from the filter module 2, which is open at the top, into the environment 4. Alternatively, the filter module 2 could also be designed such that the exhaust gas stream flows through the filter module 2 from top to bottom. However, this is not preferred.

The filter module 2 has a lower filter layer 5 and an upper filter layer 6 through which the exhaust gas stream flows in succession. The filter layers 5,6 are designed as bulk layers. As filter material, the filter layers 5,6 presently have wood chips of a coniferous wood. The filter layers 5,6 are each supported by a grid structure 7,8 extending at least substantially in the horizontal direction RH. The grid structures 7,8 are each formed by elongated grid elements 9,10 arranged crosswise, which in the present case rest loosely on one another. In the illustrated and thus preferred embodiment, the lowermost grid elements 9 of the two grid structures 7,8 are designed as wooden beams and the remaining grid elements 10 arranged above them as wooden slats. Between the lower grid structure 7 and the lower filter layer 5, and between the upper grid structure 8 and the upper filter layer 6, a supporting layer 11 in the form of a plastic mesh is arranged in each case. Via the support layers 11, the filter layers 5,6 are each supported on the grid structure 7,8 carrying the respective filter layer 5,6. In alternative biofilters, three or four filter layers, each supported by a grid structure, can also be provided one above the other in this way.

The grid structures 7,8 are supported by a supporting frame 12. The supporting framework 12 is designed as a tubular frame consisting essentially of horizontal and vertical support tubes 13,14, which are made of a galvanized steel material. The lowest grid elements 9 of the two grid structures 7,8 rest loosely on the horizontal support tubes 13 of the supporting framework 12. The horizontal support tubes 13 are in turn supported on the vertical support tubes 14 of the supporting framework 12. In this case, the vertical support tubes 14 supporting the upper grid structure 8 extend through the lower filter layer 5 and the lower grid structure 7. In this way, the supporting framework 12 supports substantially the entire weight force of both grid structures 7,8 and both filter layers 5,6 on the bottom 15 of the filter module 2.

An inflow chamber 16,17 is arranged below each of the grid structures 7,8. The lower inflow chamber 16 is essentially bounded in the vertical downward direction RV by the bottom 15 of the filter module 2 and in the vertical upward direction RV by the lower grid structure 7. The upper inflow chamber 17 is bounded at the bottom by the lower filter layer 5 and at the top by the upper grid structure 8. To the sides, both inflow chambers 16,17 are essentially bounded by the side walls 18 of the filter module 2. The lower inflow chamber 16 has a height HA of 70 cm and the upper inflow chamber 17 has a height HA of 50 cm.

For moistening the filter material of the filter layers 5,6, the biofilter 1 has a lower and an upper moistening device 19,20, the lower moistening device 19 being assigned to the lower filter layer 5 and the upper moistening device 20 being assigned to the upper filter layer 6. In this connection, the moistening devices 19,20 each have a plurality of nozzles 21 with which a moistening fluid can be applied to the filter layers 5,6. The nozzles 21 of the upper moistening device 20 are held by holding elements 22, each of which is inserted into the upper filter layer 6. The nozzles 21 of the lower moistening device 19, on the other hand, are held suspended from supply lines 23 of the lower moistening device 19, which in the present case are designed as flexible hoses. The supply lines 23 of the lower moistening device 19 extend in the vertical direction RV through the upper grid structure 8 and the upper filter layer 6. In the vicinity of the surface of the upper filter layer 6, the supply lines 23 of the lower moistening device 19 are connected to the supply lines 24 of the nozzles 21 of the upper moistening device 20, which in the illustrated embodiment example, however, by no means necessarily run just below the surface of the upper filter layer 6.

The sections of the supply lines 23 of the lower moistening device 19, which extend through the upper filter layer 6 and the upper grid structure 8, are arranged in line duct 25, which in the present case also extend through both the upper filter layer 6 and the upper grid structure 8. In this connection, the line duct 25 are formed in a simple manner as at least substantially rigid tubes which are attached in a manner not shown to at least one of the grid elements 9,10 of the upper grid structure 8. For representational reasons, the nozzles 21 of the lower moistening device 19 are shown in FIG. 1 to be larger than the diameters of the tubes forming the line duct 25. In fact, however, the nozzles 21 of the lower moistening devices 19 are made smaller than the cross-sections of the line duct 25, so that the nozzles 21 can be inserted into the upper inflow chamber 17 from above through the line duct 25 in a simple manner and can also be withdrawn again.

The nozzles 21 of the moistening devices 19,20 are controlled by a control device 26 of the biofilter 1. Thereby, the control device 26 is connected to several moisture sensors 27, which are arranged in the filter layers 5,6. The moisture sensors 27 measure the moisture of the filter material in the filter layers 5,6. Thus, the control device 26 can control the nozzles 21 depending on the measured moisture values measured by the moisture sensors 27. In this way, the moistening of the filter material by the moistening devices 19,20 can be adapted not only to changing process parameters, but also to intermittent rainfall that hits the filter module 2, which is open at the top, and thus contributes to the humidification of the filter material. In this context, a drain 28 arranged at the bottom 15 of the filter module 2 ensures that no excess water accumulates in the area of the bottom 15, which can occur in the event of over-wetting of the filter material, for example due to heavy rainfall.

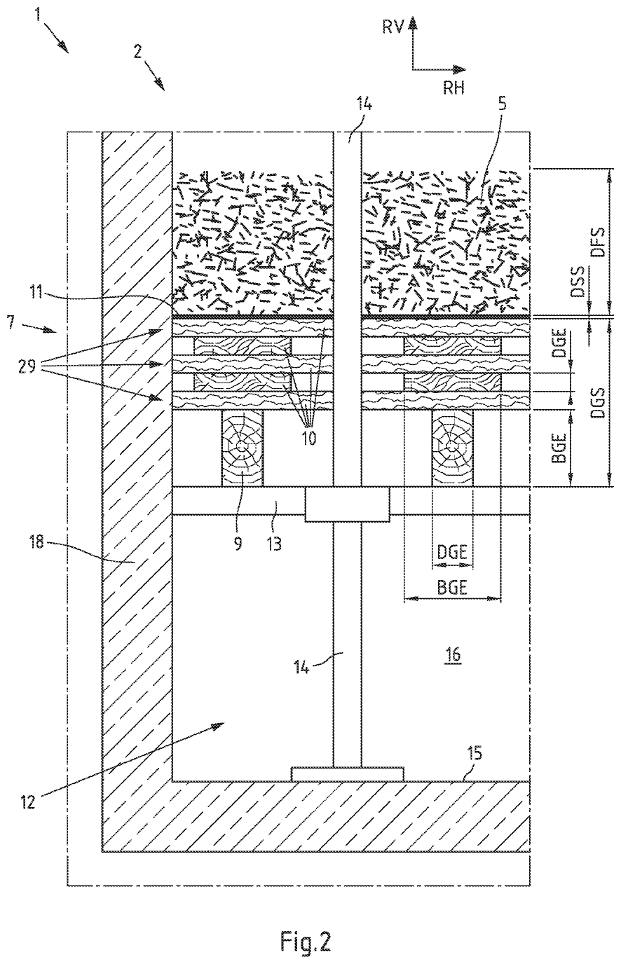

In FIG. 2, a detail of the biofilter 1 according to the section II shown in FIG. 1 is shown in a schematic vertical sectional view. The grid elements 9,10 of the lower grid structure 7 lie crosswise on top of each other and are otherwise unconnected to each other. The lowest grid elements 9 are formed as beams, while the remaining grid elements 10 are formed as battens, boards or planks. The lowermost grid elements 9 would therefore not have to be regarded as part of the grid structures 7,8, but could also be understood as part of the supporting framework 12. In any case, in the illustrated embodiment example of a biofilter 1, several, more precisely three, grid layers 29 consisting of grid elements 9,10 provided crosswise are provided. Both the grid layers and the grid structures and the grid elements extend at least substantially in a horizontal direction.

In the biofilter 1 shown, which is preferred in this respect, the lower filter layer 5 has a layer thickness DFS of approx. 70 cm and the lower grid structure 7 has a layer thickness DGS of approx. 80 cm. The support layer 11 arranged between the lower grid structure 7 and the lower filter layer 5 has a layer thickness DSS of less than 1 cm. The lowest grid elements 9 of the lower grid structure 7, which are in the form of beams, have a thickness DGE of 8 cm and a width BGE of 15 cm. The remaining grid elements 10 of the lower grid structure 7, which are in the form of battens, have a thickness DGE of 3 cm and a width BGE of 18 cm.

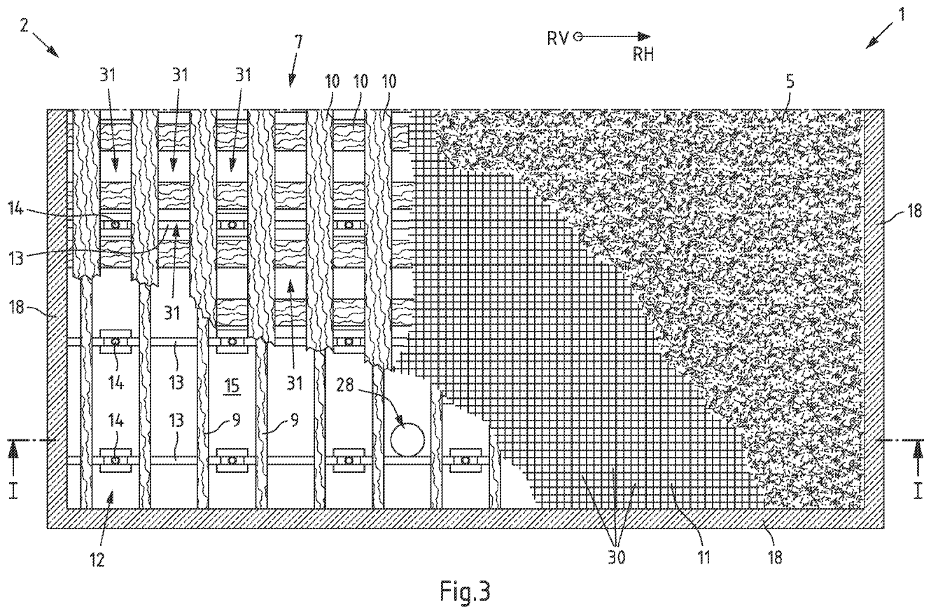

In FIG. 3, a detail of the biofilter 1 is shown in a schematic horizontal sectional view along the sectional plane III-III shown in FIG. 1, wherein in sections the lower filter layer 5, the lower support layer 11 and/or grid elements 9,10 of the lower grid structure 7 are not shown. The meshes forming the support layers 11 arranged between the filter layers 5,6 and the grid structures 7,8 each have a plurality of passage openings 30. In this case, the passage openings 30 are designed in such a way that fine components of the filter material of the filter layers 5,6, for example decomposed by the microorganisms present in the filter module 2, can fall through the passage openings 30, but larger, unrotted components of the filter material cannot. Against this background, the nets forming the supporting layers 11 have a mesh size of approx. 3 cm in the illustrated and thus preferred embodiment example.

The grid elements 9,10 of the grid structures 7,8 are arranged in the illustrated and in this respect preferred embodiment example in such a way that they cross at least substantially at right angles. Thereby, a plurality of grid openings 31 are provided within the grid structures 7,8 as seen in vertical direction RV, which in the depicted and in this respect preferred biofilter 1 are each delimited by two intersecting pairs of parallel grid elements 9,10 and are arranged at least substantially congruent to each of the three grid layers 29 provided one above the other.

### List of reference signs

1 Biofilter
2 Filter module
3 Inlet opening
4 Surroundings
5,6 Filter layer
7,8 Grid structure
9,10 Grid element
11 Support layer
12 Supporting framework
13,14 Support tube
15 Floor
16,17 Inflow chamber
18 Sidewall
19,20 Moistening device
21 Nozzle
22 Holding element
23,24 supply line
25 Line duct
26 Control device
27 Moisture sensor
28 Drain
29 Grid layer
30 Opening
31 Grid opening
BGE Width of the grid element
DFS Thickness of the filter layer
DGE Thickness of the grid element
DGS Layer thickness of the grid structure DSSupport layer thickness
HA Height of the inflow chamber
RH Horizontal direction
RV Vertical direction

1-18. (canceled)

19. A biofilter for biological purification of an exhaust gas stream containing impurities, having at least one filter module through which the exhaust gas stream is to flow, the filter module having at least one filter layer comprising an organic filter material, and the at least one filter layer being supported by at least one, in particular at least substantially horizontally oriented, grid structure,
wherein
the at least one grid structure is formed by at least substantially rectangular crosswise and arranged on top of each other elongated, at least substantially horizontally aligned, grid elements in the form of wooden slats.

20. The biofilter according to claim 19,
wherein
the grid elements of the at least one grid structure are each lath-shaped, beam-shaped and/or rod-shaped and/or in that the grid elements of the at least one grid structure are at least substantially unconnected to one another and/or are connected to one another releasably, in particular positively and/or non-positively, and/or in that the grid elements of the at least one grid structure are formed from wood and/or a wood material.

21. The biofilter according to claim 19,
wherein
the at least one grid structure is formed from at least two, preferably at least three, in particular at least four, in particular arranged on top of each other and/or horizontally aligned grid layers, and in that, preferably, the grid layers are each formed by crosswise arranged elongated grid elements.

22. The biofilter according to claim 19,
wherein
the grid elements of the at least one grid structure and/or of the grid layers cross one another at least substantially at right angles, and/or in that grid openings of a width and/or length of at least 10 cm, preferably at least 15 cm, in particular at least 20 cm, and/or at most 120 cm, preferably at most 80 cm, in particular at most 60 cm, are provided within the at least one grid structure and/or the grid layers, as seen in the vertical direction (RV).

23. The biofilter according to claim 19,
wherein
the grid elements occupy at least 20% by volume, preferably at least 30% by volume-%, in particular at least 35% by volume, and/or at most 70% by volume, preferably at most 60% by volume, in particular at most 55% by volume, of the volume of the at least one grid structure.

24. The biofilter according to claim 19,
wherein
the grid elements of the at least one grid structure each have a length of at least 80 cm, preferably at least 120 cm, in particular at least 160 cm, and/or at most 10 m, preferably at most 8 m, in particular at most 6 m, and/or a thickness (DGE) of at least 1 cm, preferably at least 2 cm, in particular at least 3 cm, and/or at most 15 cm, preferably at most 10 cm, in particular at most 5 cm, and/or a width (BGE) of at least 5 cm, preferably at least 10 cm, in particular at least 15 cm, and/or at most 80 cm, preferably at most 60 cm, in particular at most 40 cm.

25. The biofilter according to claim 19,
wherein
the at least one filter layer is designed as a bulk layer and/or that the filter material of the at least one filter layer comprises wood chips, in particular coniferous wood chips, bark mulch, fibrous peat, coconut fibers, torn root wood, biowaste compost, heather, wood wool and/or wood pellets.

26. Biofilter according to claim 19,
wherein
between the at least one filter layer and the at least one grid structure, a supporting layer having a plurality of passage openings is provided for supporting the filter layer above the grid structure, and in that, preferably, the supporting layer is formed at least substantially from metal or plastic, in particular polyethylene or polypropylene, and/or by at least one grid, perforated grid, mesh and/or fabric.

27. The biofilter according to claim 19,
wherein
the at least one grid structure has a layer thickness (DGS) of at least 20 cm, preferably at least 30 cm, in particular at least 40 cm, and/or at most 100 cm, preferably at most 80 cm, in particular at most 60 cm, and/or in that the at least one filter layer has a layer thickness (DFS) of at least 30 cm, preferably at least 40 cm, in particular at least 50 cm, and/or at most 150 cm, preferably at most 125 cm, in particular at most 100 cm, and/or in that the at least one support layer has a layer thickness (DSS) of at most 5 cm, preferably at most 3 cm, in particular at most 1 CM.

28. The biofilter according to claim 19,
wherein
an inflow chamber for the exhaust gas flow is provided below the at least one grid structure, and in that, preferably, the at least one inflow chamber has a height (HA) of at least 20 cm, preferably at least 30 cm, in particular at least 40 cm, and/or at most 120 cm, preferably at most 100 cm, in particular at most 80 cm.

29. The biofilter according to claim 19,
wherein
the at least one filter module has at least two, preferably at least three, filter layers each supported by a grid structure, and in that, preferably, a support layer is provided between the filter layers and the grid structures in each case and/or an inflow chamber is provided under each grid structure.

30. The biofilter according to claim 19,
wherein
a supporting framework is provided for supporting the at least one grid structure, in particular at least in sections in the at least one inflow chamber, and in that, preferably, the supporting framework supports at least substantially the entire weight force of the at least one grid structure and the at least one filter layer on the bottom of the filter module and/or the supporting framework supports at least one lower grid structure and one upper grid structure and extends through the filter layer supported by the lower grid structure and at least substantially through the inflow chamber arranged below the upper grid structure.

31. The biofilter according to claim 30,
wherein
the supporting framework is formed at least substantially from a steel material, in particular a galvanized steel material, a stainless steel material and/or a plastic-coated steel material, a plastic, in particular polyethylene and/or polypropylene, from wood or a wood material, preferably from coniferous wood, and/or in that the supporting frame is designed as a tubular frame.

32. The biofilter according to claim 19,
wherein
at least one moistening device for moistening the filter layer is associated with the at least one filter layer, and in that, preferably, the at least one moistening device has at least one nozzle for applying a water-containing moistening fluid to the filter layer.

33. The biofilter of claim 32,
wherein
the filter module has at least one lower filter layer and at least one upper filter layer, and in that at least one supply line of the moistening device assigned to the lower filter layer extends at least partially, in particular at least essentially in the vertical direction (RV), through the upper filter layer, and in that, preferably, the at least one nozzle assigned to the lower filter layer is held on the at least one supply line, in particular suspended, and/or in the inflow chamber of the upper filter layer.

34. The biofilter of claim 33,
wherein
the at least one supply line is arranged in sections in at least one line duct extending at least substantially through the upper filter layer, in particular formed by a pipe and/or a hose, and in that, preferably, the at least one nozzle associated with the lower filter layer is passed through the at least one line shaft.

35. The biofilter according to claim 33,
wherein
a control device is provided for controlling the at least one moistening device, in particular as a function of at least one measured moisture value measured by at least one moisture sensor, and in that, preferably, the at least one moisture sensor is designed for measuring the filter material moisture of the at least one filter layer.

36. The biofilter according to claim 19,
wherein
the at least one filter module is open at the top, in particular at least substantially over the entire horizontal extent of the at least one filter layer.
